(19) United States
(12) Patent Application Publication
(10) Pub. No.: US 2024/0030611 A1
(43) Pub. Date: Jan. 25, 2024

(54) PATCH ANTENNA

(71) Applicant: AMOTECH CO., LTD., Incheon (KR)

(72) Inventor: Chul HWANG, Incheon (KR)

(73) Assignee: AMOTECH CO., LTD., Incheon (KR)

(21) Appl. No.: 18/213,530

(22) Filed: Jun. 23, 2023

Related U.S. Application Data
(63) Continuation of application No. 17/275,589, filed on Mar. 11, 2021, now abandoned.

(30) Foreign Application Priority Data
Sep. 12, 2018 (KR) 10-2018-0109188

(51) Int. Cl. H01Q 9/04

(52) U.S. Cl. CPC H01Q 9/0457

(57) ABSTRACT

Disclosed is a patch antenna in which coupling gaps are formed between a lower patch and feed pins so as to maximize the performance of the antenna. The disclosed patch antenna comprises: a base layer; an upper patch disposed on the upper surface of the base layer; a lower patch disposed on the lower surface of the base layer; and feed pins passing through the base layer, upper patch, and lower patch, wherein the feed pins are spaced from the upper patch and thereby form coupling gaps.

### TECHNICAL FIELD

The present disclosure relates to a patch antenna for an electronic device, and more particularly, to a patch antenna which receives a frequency in an ultra wideband including signals having a GPS frequency band and a GNSS frequency band.

### BACKGROUND ART

A shark antenna for a vehicle is installed to improve a signal reception rate of electronic devices installed within a vehicle. A shark antenna for a vehicle is installed outside a vehicle.

A common shark antenna for a vehicle includes a global positioning system (GPS) antenna for providing location information service chiefly used in a vehicle. Recently, as electronic devices such as DMB and audio devices are installed, multiple antennas for receiving signals having frequency bands, such as GNSS (e.g., GPS (U.S.A) and GLONASS (Russia)), SDARS (Sirius, XM), Telematics, FM, and T-DMB, are also embedded in a shark antenna for a vehicle.

Recently, the size of a patch antenna is reduced according to the market and user needs. When the size of the patch antenna is reduced, a return loss is increased.

The return loss of the patch antenna can be minimized by reducing a gap between feeding pins. However, if the feeding pins become close, there is a problem in that antenna performance is degraded because interference occurs between the feeding pins.

### DISCLOSURE

### Technical Problem

The present disclosure is proposed to solve the above conventional problems, and an object of the present disclosure is to provide a patch antenna having maximized antenna performance by forming a coupling gap between a lower patch and a feeding pin. That is, an object of the present disclosure is to provide a patch antenna having maximized antenna performance by minimizing a return loss and also minimizing interference between feeding pins by forming a coupling gap between the lower patch and the feeding pin.

### Technical Solution

In order to achieve the object, a patch antenna according to an embodiment of the present disclosure includes a base layer, an upper patch disposed on a top surface of the base layer, a lower patch disposed on a bottom surface of the base layer, and a feeding pin penetrating through the base layer, the upper patch and the lower patch, wherein the feeding pin is isolated from the upper patch so that a coupling gap is formed.

A feeding hole through which the feeding pin penetrates may be formed in the upper patch. The feeding pin may be isolated from the feeding hole formed in the upper patch so that the coupling gap is formed. In this case, the width of the coupling gap may be 0.5 mm or more and 1.5 mm or less.

The feeding pin may include a first feeding pin penetrating through a third feeding hole formed in the upper patch and a second feeding pin penetrating through a fourth feeding hole formed in the upper patch. The coupling gap may include a first coupling gap formed in an isolated space between the first feeding pin and the third feeding hole and a second coupling gap formed in an isolated space between the second feeding pin and the fourth feeding hole. In this case, the width of the first coupling gap may be identical with the width of the second coupling gap.

In order to achieve the object, a patch antenna according to another embodiment of the present disclosure includes a base layer, an upper patch disposed on a top surface of the base layer, a lower patch in which a feeding hole is formed and which is disposed on a bottom surface of the base layer, and a feeding patch inserted into the feeding hole and disposed on the bottom surface of the base layer, wherein the feeding hole is isolated from the feeding patch so that a coupling gap is formed.

The area of the feeding hole may be formed to be wider than the area of the feeding patch. The outer circumference of the feeding patch may be isolated from the feeding hole so that an isolated area is formed. The isolated area may form a coupling gap. The width of the coupling gap may be 0.5 mm or more and 1.5 mm or less.

A first feeding hole and a second feeding hole may be formed in the lower patch. The feeding patch may include a first feeding patch inserted into the first feeding hole and a second feeding patch inserted into the second feeding hole. The coupling gap may include a first coupling gap formed in an isolated space between the first feeding patch and the first feeding hole and a second coupling gap formed in an isolated space between the second feeding patch and the second feeding hole. In this case, the width of the first coupling gap may be identical with the width of the second coupling gap.

In order to achieve the object, a patch antenna according to yet another embodiment of the present disclosure includes a base layer, an upper patch disposed on a top surface of the base layer, a lower patch disposed on a bottom surface of the base layer, and a feeding pin penetrating through a feeding hole formed in the base layer and the lower patch to contact with the upper patch, wherein the feeding pin is isolated from the lower patch so that a coupling gap is formed.

The area of the feeding hole formed in the lower patch may be formed to be wider than the area of a horizontal cross section of the feeding pin. The outer circumference of the feeding pin may be isolated from the feeding hole formed in the lower patch so that an isolated area is formed. The isolated area may form a coupling gap. In this case, the width of the coupling gap may be 0.5 mm or more and 1.5 mm or less.

A first feeding hole and a second feeding hole may be formed in the base layer. A third feeding hole and a fourth feeding hole may be formed in the lower patch. The feeding pin may include a first feeding pin penetrating through the first feeding hole and the third feeding hole and a second feeding pin penetrating through the second feeding hole and the fourth feeding hole. The coupling gap may include a first coupling gap formed in an isolated space between the first feeding pin and the third feeding hole and a second coupling gap formed in an isolated space between the second feeding pin and the fourth feeding hole. In this case, the width of the first coupling gap may be identical with the width of the second coupling gap.

### Advantageous Effects

According to an embodiment of the present disclosure, the patch antenna has an effect in that it can prevent the degradation of a return loss and improve antenna performance in a patch antenna having a reduced size by forming the coupling gap having a width of 0.5 mm or more and 1.5 mm or less between the lower patch and a feeding member (the feeding patch or the feeding pin).

Furthermore, the patch antenna has an effect in that it is possible to improve transmission efficiency in a patch antenna having a reduced size by forming the coupling gap having a width of 0.5 mm or more and 1.5 mm or less between the lower patch and the feeding member (the feeding patch or the feeding pin).

### DESCRIPTION OF DRAWINGS

FIG. 1 is an exploded perspective view of a patch antenna according to a first embodiment of the present disclosure.

FIG. 2 is a diagram for describing a lower patch of FIG. 1.

FIG. 3 is a diagram for describing a first feeding patch, a second feeding patch and a coupling gap of FIG. 1.

FIG. 4 is an exploded perspective view of a patch antenna according to a second embodiment of the present disclosure.

FIG. 5 is a side view of the patch antenna according to a second embodiment of the present disclosure.

FIG. 6 is an exploded perspective view of a patch antenna according to a third embodiment of the present disclosure.

FIG. 7 is a diagram for describing a base layer of FIG. 6.

FIG. 8 is a diagram for describing an upper patch of FIG. 6.

FIG. 9 is a cross-sectional view of the patch antenna of FIG. 6.

FIG. 10 is a diagram for describing a first feeding pin, a second feeding pin and a coupling gap of FIG. 6.

FIG. 11 is a graph illustrating a measured return loss of the patch antenna according to a reduction in the size.

FIG. 12 is a graph illustrating a measured return loss of a patch antenna depending on whether a coupling gap is present.

FIG. 13 is a graph illustrating a measured return loss of a patch antenna depending on the width (or size) of a coupling gap.

### MODE FOR INVENTION

Hereinafter, the most preferred exemplary embodiments of the present disclosure will be described with reference to the accompanying drawings in order to specifically describe the exemplary embodiments so that those skilled in the art to which the present disclosure pertains may easily implement the technical spirit of the present disclosure. First, in adding reference numerals to the components of each drawing, it should be noted that the same components have the same reference numerals as much as possible even if they are displayed in different drawings. Further, in describing the present disclosure, when it is determined that the detailed description of the related well-known configuration or function may obscure the gist of the present disclosure, the detailed description thereof will be omitted.

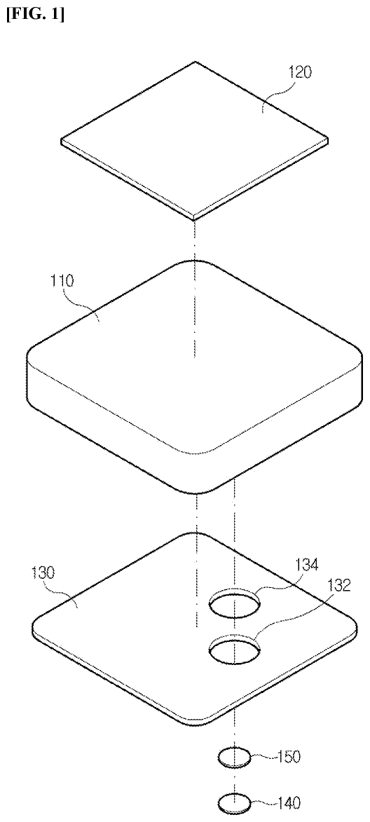

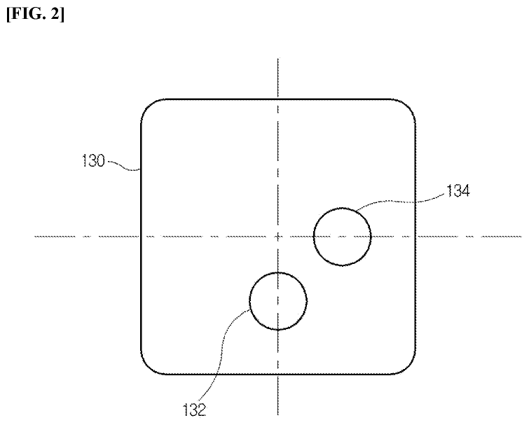

Referring to FIGS. 1 to 3, a patch antenna according to a first embodiment of the present disclosure is configured to include a base layer 110, an upper patch 120, a lower patch 130, a first feeding patch 140 and a second feeding patch 150.

The base layer 110 is made of a dielectric substance or a magnetic substance. That is, the base layer 110 is formed of a dielectric substrate composed of ceramics having characteristics, such as a high dielectric constant and a low coefficient of thermal expansion, or is formed of a magnetic substrate composed of a magnetic substance, such as ferrite.

The upper patch 120 is formed on a top surface of the base layer 110. That is, the upper patch 120 is a thin plate made of a conductive material having high electrical conductivity, such as copper, aluminum, gold or silver, and is formed on the top surface of the base layer 110. In this case, the upper patch 120 is formed in a polygon shape, such as a quadrangle, a triangle, a circle, or an octagon.

The upper patch 120 is driven through coupling feeding between the first feeding patch 140 and the second feeding patch 150, and receives a signal (i.e., a frequency including location information) transmitted by GPS satellites and GLONASS satellites.

The lower patch 130 is formed on a bottom surface of the base layer 110. That is, the lower patch 130 is a thin plate made of a conductive material having high electrical conductivity, such as copper, aluminum, gold or silver, and is formed on the bottom surface of the base layer 110.

A plurality of feeding holes into which the first feeding patch 140 and the second feeding patch 150 are inserted may be formed in the lower patch 130. That is, a first feeding hole 132 and a second feeding hole 134 are formed in the lower patch 130. The first feeding patch 140 is inserted into the first feeding hole 132, and the second feeding patch 150 is inserted into the second feeding hole 134. In this case, a virtual line that connects the first feeding hole 132 and the center point of the lower patch 130 and a virtual line that connects the second feeding hole 134 and the center point of the lower patch 130 are formed so that they intersect each other to form a set angle. In this case, the set angle is preferably formed 90 degrees, but may be formed in a range of 70 degrees or more and 110 degrees or less.

The first feeding patch 140 and the second feeding patch 150 may be inserted and formed in feeding holes formed in the lower patch 130. That is, the first feeding patch 140 is inserted and formed within the first feeding hole 132 of the lower patch 130. The second feeding patch 150 is inserted and formed within the second feeding hole 134 of the lower patch 130. In this case, the first feeding patch 140 is formed to be isolated from the outer circumference of the first feeding hole 132 at a predetermined interval. The second feeding patch 150 is formed to be isolated from the outer circumference of the second feeding hole 134 at a predetermined interval.

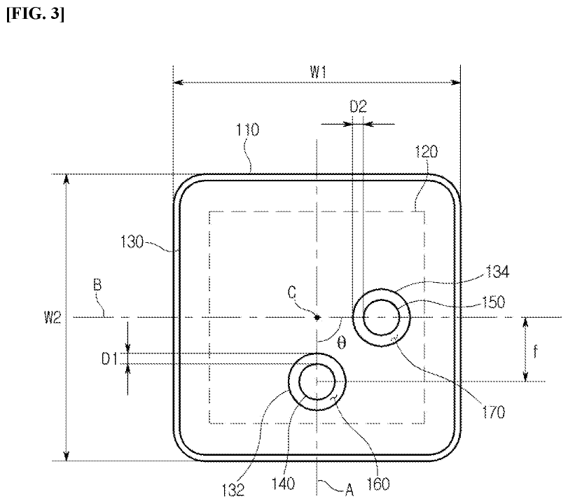

The first feeding patch 140 and the second feeding patch 150 are disposed to have a set angle with respect to the center of the lower patch 130. That is, referring to FIG. 3, a virtual line A that connects the first feeding patch 140 and the center point C of the lower patch 130 and a virtual line B that connects the second feeding patch 150 and the center point C of the lower patch 130 are formed so that they intersect each other to form a set angle θ. In this case, the set angle θ is preferably formed 90 degrees, but may be formed in a range of 70 degrees or more and 110 degrees or less. In this case, in FIG. 3, f means a distance in a y-axis (W2) direction between the center points of the first feeding patch 140 and the second feeding patch 150.

In this case, if the size of the patch antenna is formed to have an area of 25×25 (W1=25 mm, W2=25 mm) or more, performance of the patch antenna is not influenced because interference does not occur between the first feeding patch 140 and the second feeding patch 150.

However, if the size of the patch antenna is formed to have an area of 20×20 (W1=20 mm, W2=20 mm) [symbol] , performance of the patch antenna is degraded due to interference occurring because the interval between the first feeding patch 140 and the second feeding patch 150 is narrowed.

That is, if the size of the patch antenna is reduced, interference occurs between the first feeding patch 140 and the second feeding patch 150 because an isolated interval between the first feeding patch 140 and the second feeding patch 150 is narrowed. The patch antenna has a return loss reduced due to the occurrence of the interference between the first feeding patch 140 and the second feeding patch 150. As a result, performance of the antenna is degraded.

For this reason, in the patch antenna according to the first embodiment of the present disclosure, a coupling gap is formed between the lower patch 130 and a feeding patch (i.e., the first feeding patch 140 and the second feeding patch 150) so that antenna performance is not degraded although the antenna is formed to have the size equal to or less than the reference (20×20 (W1=20 mm, W2=20 mm)).

The coupling gap includes a first coupling gap 160 and a second coupling gap 170.

The first coupling gap 160 is formed between the lower patch 130 and the first feeding patch 140. That is, the first feeding hole 132 is formed to have a greater area than the first feeding patch 140. The first feeding hole 132 is isolated from the first feeding patch 140 at a predetermined interval, so that an isolated area is formed. Accordingly, the first coupling gap 160 (i.e., the isolated area) is formed between the first feeding hole 132 and the first feeding patch 140.

The second coupling gap 170 is formed between the lower patch 130 and the second feeding patch 150. That is, the second feeding hole 134 is formed to have a greater area than the second feeding patch 150. The second feeding hole 134 is isolated from the second feeding patch 150 at a predetermined interval, so that an isolated area is formed. Accordingly, the second coupling gap 170 (i.e., the isolated area) is formed between the second feeding hole 134 and the second feeding patch 150.

Each of a width D1 of the first coupling gap 160 and a width D2 of the second coupling gap 170 is formed as a width within a set range. In this case, an example in which each of the width D1 of the first coupling gap 160 and the width D2 of the second coupling gap 170 is formed as a width of approximately 0.5 mm or more and 1.5 mm or less is taken. The width D1 of the first coupling gap 160 is formed to be the same as the width D2 of the second coupling gap 170. Of course, the width D1 of the first coupling gap 160 and the width D2 of the second coupling gap 170 may be formed as different widths.

Each of the first coupling gap 160 and the second coupling gap 170 may be formed in a circular doughnut shape because each of the first feeding patch 140 and the second feeding patch 150 is commonly formed in a circle. Of course, if each of the first feeding patch 140 and the second feeding patch 150 is formed in a polygon shape, such as a triangle or a quadrangle, each of the first coupling gap 160 and the second coupling gap 170 may be formed in a polygonal doughnut shape, such as a triangle or a quadrangle.

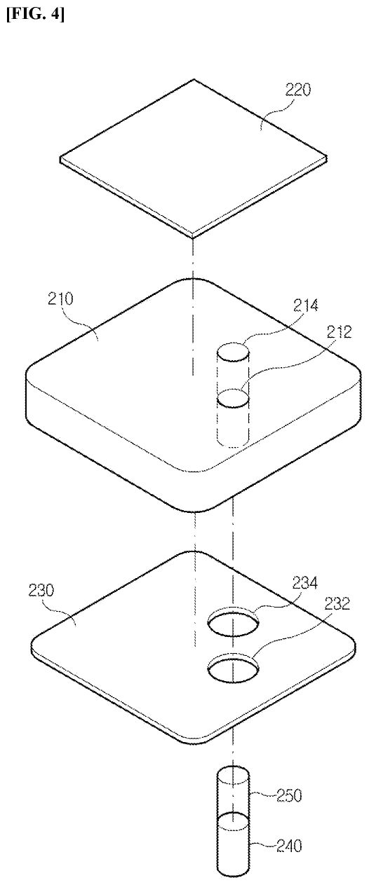

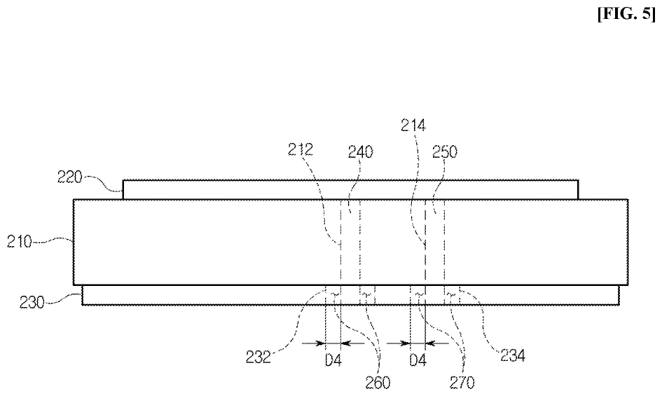

Referring to FIGS. 4 and 5, the patch antenna according to a second embodiment of the present disclosure is configured to include a base layer 210, an upper patch 220, a lower patch 230, a first feeding pin 240 and a second feeding pin 250.

The base layer 210 is made of a dielectric substance or a magnetic substance. That is, the base layer 210 is formed of a dielectric substrate composed of ceramics having characteristics, such as a high dielectric constant and a low coefficient of thermal expansion, or is formed of a magnetic substrate composed of a magnetic substance, such as ferrite.

A plurality of feeding holes is formed in the base layer 210. That is, a first feeding hole 212 into which the first feeding pin 240 is inserted therethrough and a second feeding hole 214 into which the second feeding pin 250 is inserted therethrough are formed in the base layer 210. In this case, a virtual line that connects the first feeding hole 212 and the center point of the base layer 210 and a virtual line that connects the second feeding hole 214 and the center point of the base layer 210 are formed so that they intersect each other to form a set angle. In this case, the set angle is preferably formed 90 degrees, but may be formed in a range of 70 degrees or more and 110 degrees or less.

The upper patch 220 is formed on a top surface of the base layer 210. That is, the upper patch 220 is a thin plate made of a conductive material having high electrical conductivity, such as copper, aluminum, gold or silver, and is formed on the top surface of the base layer 210. In this case, the upper patch 220 is formed in a polygon [symbol] , such as a quadrangle, a triangle, a circle, or an octagon.

A bottom surface of the upper patch 220 is electrically coupled to the feeding pins that penetrate through the base layer 210 and the lower patch 230. The upper patch 220 is driven through feeding or coupling feeding through the first feeding pin 240 and the second feeding pin 250, and receives a signal (i.e., a frequency including location information) transmitted by GPS satellites and GLONASS satellites.

The lower patch 230 is formed on a bottom surface of the base layer 210. That is, the lower patch 230 is a thin plate made of a conductive material having high electrical conductivity, such as copper, aluminum, gold or silver, and is formed on the bottom surface of the base layer 210.

A plurality of feeding holes into which the first feeding pin 240 and the second feeding pin 250 are inserted therethrough may be formed in the lower patch 230. That is, a third feeding hole 232 and a fourth feeding hole 234 are formed in the lower patch 230. The first feeding pin 240 is inserted into the third feeding hole 232 therethrough. The second feeding pin 250 is inserted into the fourth feeding hole 234 therethrough. In this case, a virtual line that connects the third feeding hole 232 and the center point of the lower patch 230 and a virtual line that connects the fourth feeding hole 234 and the center point of the lower patch 230 are formed so that they intersect each other to form a set angle. In this case, the set angle is preferably formed 90 degrees, but may be formed in a range of 70 degrees or more and 110 degrees or less.

One side of each of the first feeding pin 240 and the second feeding pin 250 penetrates through the lower patch 230 and the base layer 210 and contacts with the bottom surface of the upper patch 220. That is, the first feeding pin 240 penetrates through the third feeding hole 232 of the lower patch 230 and the first feeding hole 212 of the base layer 210, and contacts with the bottom surface of the upper patch 220. The second feeding pin 250 penetrates through the fourth feeding hole 234 of the lower patch 230 and the second feeding hole 214 of the base layer 210, and contacts with the bottom surface of the upper patch 220.

The other side of each of the first feeding pin 240 and the second feeding pin 250 is connected to a feeding unit (not illustrated) of an electronic device and supplied with feeding power. The first feeding pin 240 and the second feeding pin 250 contact with the bottom surface of the upper patch 220 formed on the top surface of the base layer 210, and supply feeding power to the upper patch 220.

The first feeding pin 240 and the second feeding pin 250 are disposed to have a set angle with respect to the center of the lower patch 230 and the base layer 210. That is, a virtual line that connects the first feeding pin 240 and the center point of the lower patch 230 and a virtual line that connects the second feeding pin 250 and the center point of the lower patch 230 are formed so that they intersect each other to form a set angle. A virtual line that connects the first feeding pin 240 and the center point of the base layer 210 and a virtual line that connects the second feeding pin 250 and the center point of the base layer 210 are formed so that they intersect each other to form a set angle. In this case, the set angle is preferably formed 90 degrees, but may be formed in a range of 70 degrees or more and 110 degrees or less.

In this case, each of the first feeding pin 240 and the second feeding pin 250 is previously fabricated in a pin form by using a conductive material having high electrical conductivity, such as copper, aluminum, gold or silver. Of course, after the base layer 210, the upper patch 220, and the lower patch 230 are stacked to form a body, the first feeding pin 240 and the second feeding pin 250 may be formed by injecting a conductive material having high electrical conductivity, such as copper, aluminum, gold or silver, into the feeding holes of the base layer 210 and the feeding holes of the lower patch 230.

In this case, if the size of the patch antenna is formed to have an area of 25×25 (W1=25 mm, W2=25 mm) or more, performance of the patch antenna is not influenced because interference does not occur between the first feeding pin 240 and the second feeding pin 250.

However, if the size of the patch antenna is formed to have an area of 20×20 (W1=20 mm, W2=20 mm) [symbol] , performance of the patch antenna is degraded due to [symbol] interference occurring because the interval between the first feeding pin 240 and the second feeding pin 250 is narrowed.

That is, if the size of the patch antenna is reduced, interference occurs between the first feeding pin 240 and the second feeding pin 250 because the isolated interval between the first feeding pin 240 and the second feeding pin 250 is narrowed. The patch antenna has a return loss reduced due to the occurrence of the interference between the first feeding pin 240 and the second feeding pin 250. As a result, performance of the antenna is degraded.

For this reason, in the patch antenna according to the first embodiment of the present disclosure, a coupling gap is formed between the lower patch 230 and the feeding pins (i.e., the first feeding pin 240 and the second feeding pin 250) so that antenna performance is not degraded although the antenna is formed to have the size equal to or less than the reference (20×20 (W1=20 mm, W2=20 mm)).

The coupling gap includes a first coupling gap 260 and a second coupling gap 270.

The first coupling gap 260 is formed between the lower patch 230 and the first feeding pin 240. That is, the third feeding hole 232 is formed to have a greater area than a horizontal cross section of the first feeding pin 240. The third feeding hole 232 is isolated from the first feeding pin 240 at a predetermined interval, so that an isolated area is formed. Accordingly, the first coupling gap 260 (i.e., the isolated area) is formed between the third feeding hole 232 and the first feeding pin 240.

The second coupling gap 270 is formed between the lower patch 230 and the second feeding pin 250. That is, the fourth feeding hole 234 is formed to have a greater area than a horizontal cross section of the second feeding pin 250. The fourth feeding hole 234 is isolated from the second feeding pin 250 at a predetermined interval, so that an isolated area is formed. Accordingly, the second coupling gap 270 (i.e., the isolated area) is formed between the fourth feeding hole 234 and the second feeding pin 250.

Each of a width D3 of the first coupling gap 260 and a width D4 of the second coupling gap 270 is formed as a width within a set range. In this case, an example in which each of the width D3 of the first coupling gap 260 and the width D4 of the second coupling gap 270 is formed as a width of approximately 0.5 mm or more and 1.5 mm or less is taken. The width D3 of the first coupling gap 260 is formed to be the same as the width D4 of the second coupling gap 270. Of course, the width D3 of the first coupling gap 260 and the width D4 of the second coupling gap 270 may be formed as different widths.

Each of the first coupling gap 260 and the second coupling gap 270 may be formed in a circular doughnut shape because a vertical cross section of each of the first feeding pin 240 and the second feeding pin 250 is commonly formed in a circle. Of course, if the vertical cross section of each of the first feeding pin 240 and the second feeding pin 250 is formed in a polygon shape, such as a triangle or a quadrangle, each of the first coupling gap 260 and the second coupling gap 270 may be formed in a polygonal doughnut shape, such as a triangle or a quadrangle.

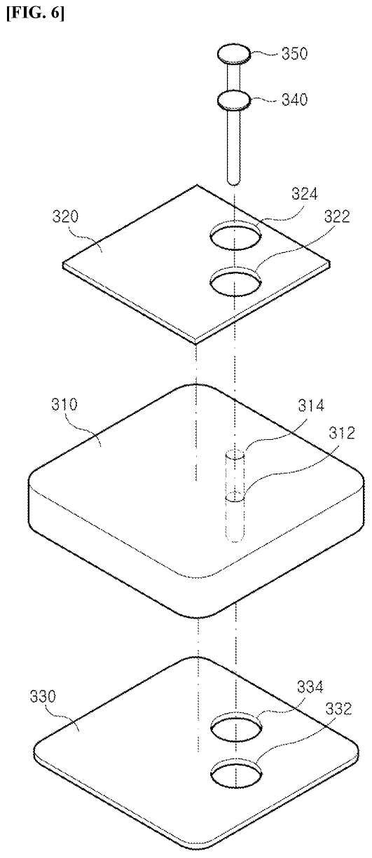

Referring to FIGS. 6 to 10, a patch antenna according to a third embodiment of the present disclosure is configured to include a base layer 310, an upper patch 320, a lower patch 330, a first feeding pin 340 and a second feeding pin 350.

The base layer 310 is made of a dielectric substance or a magnetic substance. That is, the base layer 310 is formed of a dielectric substrate composed of ceramics having characteristics, such as a high dielectric constant and a low coefficient of thermal expansion, or is formed of a magnetic substrate composed of a magnetic substance, such as ferrite.

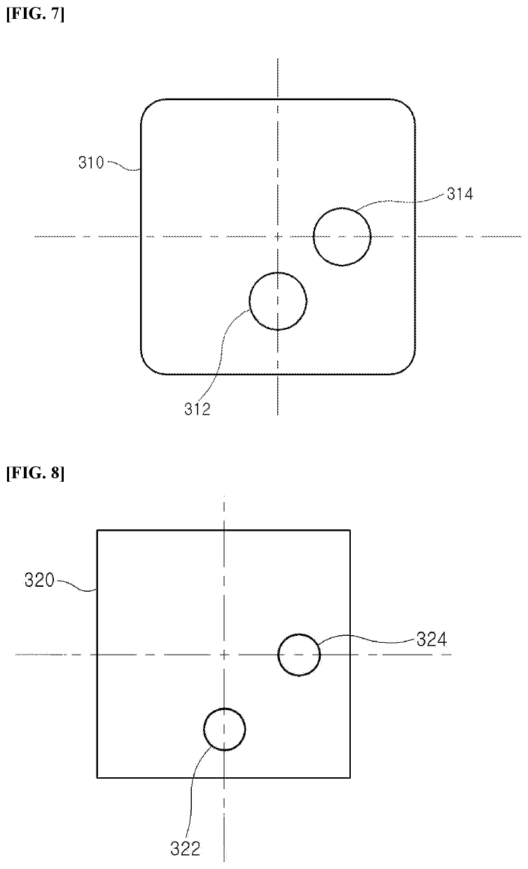

A plurality of feeding holes into which the first feeding pin 340 and the second feeding pin 350 are inserted may be formed in the base layer 310. That is, referring to FIG. 7, a first feeding hole 312 and a second feeding hole 314 are formed in the base layer 310. The first feeding pin 340 is inserted into the first feeding hole 312. The second feeding pin 350 is inserted into the second feeding hole 314. In this case, a virtual line that connects the first feeding hole 312 and the center point of the base layer 310 and a virtual line that connects the second feeding hole 314 and the center point of the base layer 310 are formed so that they intersect each other to form a set angle. In this case, the set angle is preferably formed 90 degrees, but may be formed in a range of 70 degrees or more and 310 degrees or less.

The upper patch 320 is formed on a top surface of the base layer 310. That is, the upper patch 320 is a thin plate made of a conductive material having high electrical conductivity, such as copper, aluminum, gold or silver, and is formed on the top surface of the base layer 310. In this case, the upper patch 320 is formed in a polygon shape, such as a quadrangle, a triangle, a circle, or an octagon.

A plurality of feeding holes into which the first feeding pin 340 and the second feeding pin 350 are inserted may be formed in the upper patch 320. That is, referring to FIG. 8, a third feeding hole 322 and a fourth feeding hole 324 are formed in the upper patch 320. The first feeding pin 340 is inserted into the third feeding hole 322. The second feeding pin 350 is inserted into the fourth feeding hole 324. In this case, a virtual line that connects the third feeding hole 322 and the center point of the upper patch 320 and a virtual line that connects the fourth feeding hole 324 and the center point of the upper patch 320 are formed so that they intersect each other to form a set angle. In this case, the set angle is preferably formed 90 degrees, but may be formed in a range of 70 degrees or more and 310 degrees or less.

The upper patch 320 is driven through coupling feeding between the first feeding pin 340 and the second feeding pin 350, and receives a signal (i.e., a frequency including location information) transmitted by GPS satellites and GLONASS satellites.

The lower patch 330 is formed on a bottom surface of the base layer 310. That is, the lower patch 330 is a thin plate made of a conductive material having high electrical conductivity, such as copper, aluminum, gold or silver, and is formed on the bottom surface of the base layer 310.

A plurality of feeding holes through which the first feeding pin 340 and the second feeding pin 350 penetrate may be formed in the lower patch 330. That is, a fifth feeding hole 332 and a sixth feeding hole 334 are formed in the lower patch 330. The first feeding pin 340 penetrates through the fifth feeding hole 332. The second feeding pin 350 penetrates through the sixth feeding hole 334. In this case, a virtual line that connects the fifth feeding hole 332 and the center point of the lower patch 330 and a virtual line that connects the sixth feeding hole 334 and the center point of the lower patch 330 are formed so that they intersect each other to form a set angle. In this case, the set angle is preferably formed 90 degrees, but may be formed in a range of 70 degrees or more and 310 degrees or less.

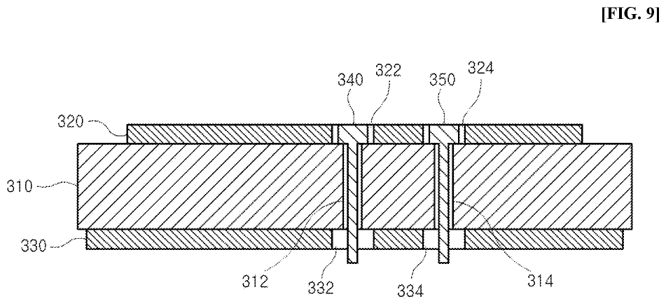

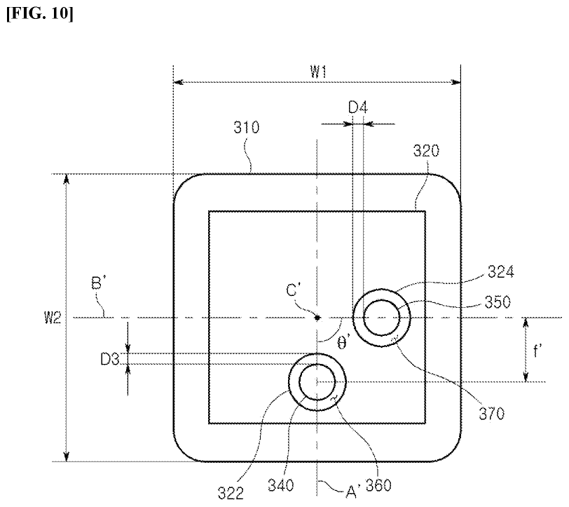

Referring to FIG. 9, the first feeding pin 340 and the second feeding pin 350 are inserted into the feeding holes formed in the base layer 310, the upper patch 320 and the lower patch 330. The heads of first feeding pin 340 and the second feeding pin 350 are disposed on the top surface of the base layer 310. The bodies of the first feeding pin 340 and the second feeding pin 350 are inserted and disposed within the base layer 310, the upper patch 320 and the lower patch 330.

The first feeding pin 340 is inserted and disposed within the first feeding hole 312 of the base layer 310, the third feeding hole 322 of the upper patch 320 and the fifth feeding hole 332 of the lower patch 330. The second feeding pin 350 is inserted and disposed within the second feeding hole 314 of the base layer 310, the fourth feeding hole 324 of the upper patch 320 and the sixth feeding hole 334 of the lower patch 330.

In this case, the outer circumference of the first feeding pin 340 is disposed to be isolated from the outer circumferences (i.e., inner wall surfaces) of the first feeding hole 312, the third feeding hole 322 and the fifth feeding hole 332 at a predetermined interval. The outer circumference of the second feeding pin 350 is disposed to be isolated from the outer circumferences (i.e., inner wall surfaces) of the second feeding hole 322, the fourth feeding hole 324 and the sixth feeding hole 334 at a predetermined interval.

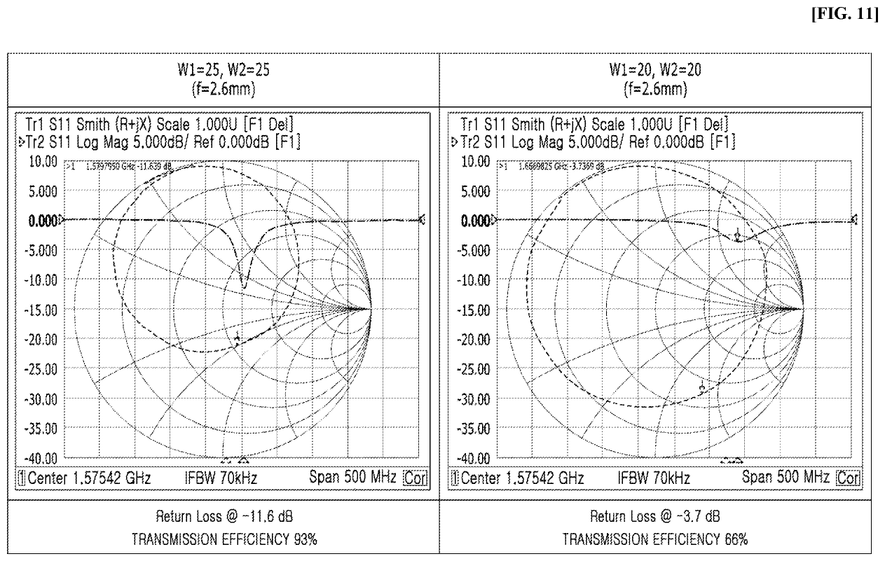

The first feeding pin 340 and the second feeding pin 350 are disposed to have a set angle with respect to the center of the patch antenna. That is, referring to FIG. 10, a virtual line A′ that connects the first feeding pin 340 and the center point C′ of the patch antenna and a virtual line B′ that connects the second feeding pin 350 and the center point C′ of the patch antenna are formed so that they intersect each other to form a set angle θ′. In this case, the set angle (θ′) is preferably formed 90 degrees, but may be formed in a range of 70 degrees or more and 310 degrees or less. In this case, in FIG. 10, f means a distance in a y-axis (W2) direction between the center points of the first feeding pin 340 and the second feeding pin 350.

The first feeding pin 340 and the second feeding pin 350 are coupled to the upper patch 320 through electromagnetic coupling.

In this case, if the size of the patch antenna is formed to have an area of 25×25 (W1=25 mm, W2=25 mm) or more, performance of the patch antenna is not influenced because interference does not occur between the first feeding pin 340 and the second feeding pin 350.

However, if the size of the patch antenna is formed to have an area of 20×20 (W1=20 mm, W2=20 mm) or less, performance of the patch antenna is degraded due to the occurrence of interference because the interval between the first feeding pin 340 and the second feeding pin 350 is narrowed. That is, if the size of the patch antenna is reduced, interference occurs because the isolated interval between the first feeding pin 340 and the second feeding pin 350 is narrowed. The patch antenna has a return loss reduced due to the occurrence of the interference between the first feeding pin 340 and the second feeding pin 350. As a result, performance of the antenna is degraded.

For this reason, in the patch antenna according to the third embodiment of the present disclosure, a coupling gap is formed between the upper patch 320 and the feeding pins (i.e., the first feeding pin 340 and the second feeding pin 350) so that antenna performance is not degraded although the antenna is formed to have the size equal to or less than the reference (20×20 (W1=20 mm, W2=20 mm)).

The coupling gap includes a first coupling gap 360. The first coupling gap 360 is formed between the upper patch 320 and the first feeding pin 340. That is, the third feeding hole 322 is formed to have a greater area than the first feeding pin 340. The third feeding hole 322 is isolated from the first feeding pin 340 at a predetermined interval, so that an isolated area is formed. Accordingly, the first coupling gap 380 (i.e., the isolated area) is formed between the third feeding hole 322 and the first feeding pin 340.

The coupling gap further includes a second coupling gap 370. The second coupling gap 370 is formed between the upper patch 320 and the second feeding pin 350. That is, the fourth feeding hole 324 is formed to have a greater area than the second feeding pin 350. The fourth feeding hole 324 is isolated from the second feeding pin 350 at a predetermined interval, so that an isolated area is formed. Accordingly, the second coupling gap 390 (i.e., the isolated area) is formed between the fourth feeding hole 324 and the second feeding pin 350.

Each of a width D3 of the first coupling gap 360 and a width D4 of the second coupling gap 370 is formed as a width within a set range. In this case, an example in which each of the width D3 of the first coupling gap 360 and the width D4 of the second coupling gap 370 is formed as a width of approximately 0.5 mm or more and 1.5 mm or less is taken. The width D3 of the first coupling gap 360 is formed to be the same as the width D4 of the second coupling gap 370. Of course, the width D3 of the first coupling gap 360 and the width D4 of the second coupling gap 370 may be formed as different widths.

In general, each of the first coupling gap 360 and the second coupling gap 370 may be formed in a circular doughnut shape because a head portion of each of the first feeding pin 340 and the second feeding pin 350 is formed in a circle.

Of course, if the head portion of each of the first feeding pin 340 and the second feeding pin 350 is formed in a polygon, such as a triangle or a quadrangle, each of the first coupling gap 360 and the second coupling gap 370 may be formed in a polygonal doughnut shape, such as a triangle or a quadrangle.

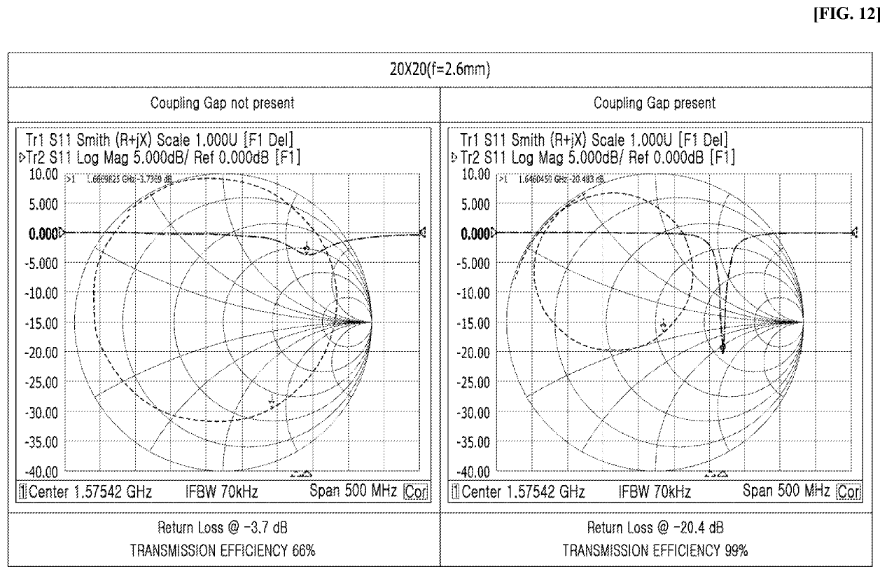

Referring to FIG. 11, a patch antenna fabricated to have a size of 25×25 and an interval of approximately 2.6 mm between a first feeding line and a second feeding line has a return loss of approximately −11.6 dB and has transmission efficiency of about approximately 93%. In this case, the first feeding line and the second feeding line correspond to the first feeding patch and second feeding patch of the first embodiment of the present disclosure and the first feeding pin and second feeding pin of the second embodiment and third embodiment of the present disclosure.

In this case, a patch antenna fabricated to have a reduced size of 20×20 in the state in which the interval between the first feeding line and the second feeding line is [symbol] approximately 2.6 mm has a return loss of about −3.7 dB increased by approximately 7.9 dB and transmission efficiency reduced by approximately 66%, compared to the patch antenna of 25×25 in size.

The reason for this is that interference occurs between the first feeding line and the second feeding line due to a reduction in the size of the patch antenna.

In the patch antenna according to an embodiment of the present disclosure, the coupling gap is formed in order to solve the aforementioned problem.

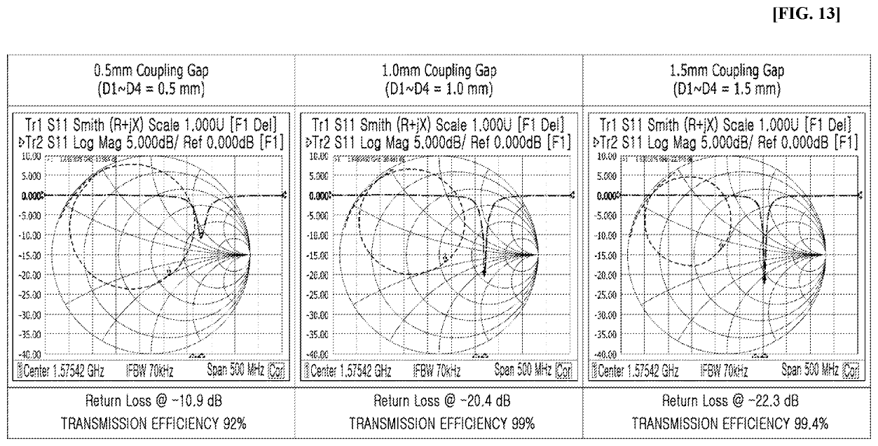

Referring to FIG. 12, if the coupling gap is not formed in the patch antenna fabricated to have the size of 20×20 (f=2.6 mm), the patch antenna has a return loss of approximately −3.7 dB and transmission efficiency of approximately 66%.

In this case, if the coupling gap is formed in the patch antenna having the same size, the patch antenna has a return loss of about −20.4 dB reduced by approximately 16.7 dB and transmission efficiency of approximately 99% increased by approximately 33%, compared to a patch antenna in which the coupling gap is not formed.

As described above, the patch antenna according to an embodiment of the present disclosure satisfies a return loss and transmission efficiency necessary for the market by forming the coupling gap.

Referring to FIG. 13, if the width of the coupling gap formed in the patch antenna fabricated to have the size of 20×20 (f=2.6 mm) is increased in unit of approximately 0.5 mm, it can be seen that the return loss and transmission efficiency of the patch antenna are improved. That is, the patch antenna in which the width of the coupling gap is formed to be approximately 0.5 mm has a return loss of approximately −10.9 dB and transmission efficiency of approximately 92%.

A patch antenna formed to be approximately 1.0 mm in the size of the coupling gap by increasing the width of the coupling gap has a return loss of approximately −20.4 dB reduced by approximately 9.5 dB and transmission efficiency of approximately 99% increased by approximately 7%, compared to the patch antenna having the width of 0.5 mm.

A patch antenna formed to be approximately 1.5 mm in the width of the coupling gap by increasing the width of the coupling gap has a return loss of approximately −22.3 dB reduced by approximately 11.4 dB and transmission efficiency of approximately 99.4% increased by approximately 7.4%, compared to the patch antenna having the width of 0.5 mm.

As described above, when the patch antenna is formed to be approximately 0.5 mm or more and 1.5 mm or less in the width of the coupling gap, a return loss and transmission efficiency required for an antenna market can be satisfied.

In this case, if the width of the coupling gap is less than approximately 0.5 mm or is more than 1.5 mm, the return loss and transmission efficiency required for the antenna market cannot be satisfied because transmission efficiency is degraded due to an increased return loss.

Accordingly, in the patch antenna according to an embodiment of the present disclosure, the coupling gap is formed to have a width of approximately 0.5 mm or more and 1.5 mm or less.

As described above, although the preferred exemplary embodiment according to the present disclosure has been described, it is understood that changes may be made in various forms, and those skilled in the art may practice various changed examples and modified examples without departing from the claims of the present disclosure.

1. A patch antenna comprising:
a base layer;
an upper patch disposed on a top surface of the base layer;
a lower patch disposed on a bottom surface of the base layer; and
a feeding pin penetrating through the base layer, the upper patch and the lower patch,
wherein the feeding pin is isolated from the upper patch so that a coupling gap is formed.

2. The patch antenna of claim 1, wherein:
wherein a feeding hole through which the feeding pin penetrates is formed in the upper patch, and
wherein the feeding pin is isolated from the feeding hole formed in the upper patch so that the coupling gap is formed.

3. The patch antenna of claim 1,
wherein a width of the coupling gap is 0.5 mm or more and 1.5 mm or less.

4. The patch antenna of claim 1,
wherein the feeding pin comprises:
a first feeding pin penetrating through a third feeding hole formed in the upper patch; and
a second feeding pin penetrating through a fourth feeding hole formed in the upper patch.

5. The patch antenna of claim 4,
wherein the coupling gap comprises:
a first coupling gap formed in an isolated space between the first feeding pin and the third feeding hole; and
a second coupling gap formed in an isolated space between the second feeding pin and the fourth feeding hole.

6. The patch antenna of claim 5,
wherein a width of the first coupling gap is identical with a width of the second coupling gap.
